(19) United States
(12) Patent Application Publication
(10) Pub. No.: US 2023/0104436 A1
(43) Pub. Date: Apr. 6, 2023

(54) MICROPUMP HAVING A CAPILLARY STRUCTURE, AND USE

(71) Applicant: Alfred-Wegener-Institut, Helmholtz-Zentrum fuer Polar- und Meeresforschung, Bremerhaven (DE)

(72) Inventors: Svenja Kroener, Bayreuth (DE); Ulf-Georg Bickmeyer, Bremerhaven (DE)

(21) Appl. No.: 17/914,768

(22) PCT Filed: Apr. 6, 2021
(86) PCT No.: PCT/DE2021/100321

§ 371 Date: Sep. 27, 2022

(30) Foreign Application Priority Data
Apr. 8, 2020 (DE) 10 2020 109 785.9

(51) Int. Cl. B01L 3/00; B01L 3/02; G01N 21/64

(52) U.S. Cl. CPC B01L 3/50273; B01L 3/022; B01L 3/0293; G01N 21/6486; B01L 2300/0681; B01L 2300/0838; B01L 2400/0406; G01N 2021/6482

(57) ABSTRACT

A micropump for exchanging liquid between a supply region and a working region is provided. An enclosed gas region is located above the working region. The micropump includes a capillary pipette having a closed pipette tip on a first end, an open pipette inlet disposed opposite the first end, and a pipette section enclosing the working region and disposed in a direction of the open pipette inlet from the closed pipette tip. The micropump further includes a liquid-permeable filter covering the open pipette inlet and connected to the supply region. The micropump additionally includes a capillary structure extending through the gas region between the closed pipette tip and the liquid-permeable filter.

### CROSS-REFERENCE TO PRIOR APPLICATIONS

This application is a U.S. National Phase application under 35 U.S.C. § 371 of International Application No. PCT/DE2021/100321, filed on Apr. 6, 2021, and claims benefit to German Patent Application No. DE 10 2020 109 785.9, filed on Apr. 8, 2020. The International Application was published in German on Oct. 14, 2021 as WO/2021/204329 A1 under PCT Article 21(2).

### FIELD

The disclosure relates to a micropump for exchanging liquid between a supply region and a working region by means of a capillary structure, wherein an enclosed gas region is located above the working region, and to a use of such a micropump.

### BACKGROUND

Numerous technical applications require the transport of minute quantities of liquids. In this context, it is necessary to overcome occurring surface tensions and to utilize capillary forces.

DE 198 60 227 C1 describes a micropump for a miniaturized gas generating system in the fuel cell technology. Minute quantities of water and hydrocarbon have to be fed to a conversion process in a working region in order to generate hydrogen. The liquid to be transported is stored in an enclosed supply region. The liquid is transported from the supply region into the working region by means of a capillary structure in the form of a hollow fiber bundle and further processed in the working region. The exchange of liquid respectively utilizes diffusion forces or the diffusion pressure of the molecules in the liquid occurring as a result of the capillary effect. No pressure above the ambient pressure is applied to the micropump from outside. A gas is generated in the process in an enclosed gas region above the liquid in the working region. The gas is discharged from the working region through an outlet. The liquid is not transported through the enclosed gas region.

EP 1 835 275 A2 discloses a pipette-like micropump for extracting a liquid from another liquid, wherein said micropump can aspirate different liquids from different supply regions through an open pipette tip by means of a capillary structure. The aspiration takes place successively such that the initially aspirated liquid can be treated with the subsequently aspirated liquid. An open gas region in the form of ambient air is located above the supply region that does not form part of the micropump. However, the liquid once again does not have to be transported through this ambient air. This applies analogously to the needle known from DE 199 33 838 A1, wherein said needle serves for transferring liquids between a supply region and a working region and has capillary structures in the region of its tip. These capillary structures can aspirate liquid by means of capillary forces when the needle tip is immersed in a supply region and retain said liquid until it should be discharged again at a different location. An open gas region is once again formed by the ambient air.

Furthermore, FIG. 1 of DE 197 11 270 A1 discloses a micropump for fluid mediums that operates with a vibration generator or sound generator, wherein the pump chamber of said micropump consists of the interior of a capillary tube.

### SUMMARY

In an embodiment, the present disclosure provides a micropump for exchanging liquid between a supply region and a working region. An enclosed gas region is located above the working region. The micropump includes a capillary pipette having a closed pipette tip on a first end, an open pipette inlet disposed opposite the first end, and a pipette section enclosing the working region and disposed in a direction of the open pipette inlet from the closed pipette tip. The micropump further includes a liquid-permeable filter covering the open pipette inlet and connected to the supply region. The micropump additionally includes a capillary structure extending through the gas region between the closed pipette tip and the liquid-permeable filter.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic cross section through a micropump with a constructively delimited supply region; and

FIG. 2 shows a schematic cross section through a micropump with a supply region in the form of a portion of an open body of water.

### DETAILED DESCRIPTION

Relative to the generic micropumps according to the related prior art described above, the present disclosure provides for enhancing a micropump such that liquid can also be transported through an enclosed gas region in a simple and cost-efficient manner. Advantageous modifications are disclosed and described in greater detail below.

According to an aspect of the disclosure, a capillary pipette with a closed pipette tip on its lower end and an open pipette inlet lying opposite thereof is provided, wherein the working region is enclosed by a pipette section above the closed pipette tip and the open pipette inlet is covered by a liquid-permeable filter, and wherein the filter is connected to the supply region. The capillary structure extends through the gas region between the closed pipette tip and the filter.

The micropump includes a specially modified capillary pipette. A conventional capillary pipette in commercially available and unmodified form is also referred to as “Pasteur pipette.” It has an open pipette tip on the end of a capillary tube such that minute liquid volumes can also be dripped out. An open pipette inlet for introducing liquid into the pipette is located on the other end of the capillary tube. In the inventive micropump, the pipette tip is closed such that a very small liquid volume, which cannot be dripped out downward, can be accumulated in the interior of the capillary tube above the pipette tip. A pipette section lying above the closed pipette tip encloses the working region of the claimed micropump, in which the stored liquid can be examined or processed. The enclosed gas region is located above the working region in the modified capillary pipette. The liquid in the working region has no direct contact with the liquid in the supply region, but rather is separated therefrom by the gas region. The working region of the inventive micropump is delimited by the closed pipette tip on its one side, as well as by the gas region on its other side, and constantly defined in its small volume. The liquid to be exchanged typically is water or an aqueous liquid. However, all other liquids that are subject to the effect of capillary forces and in the process build up a diffusion pressure, e.g. liquid hydrogen, can also be reliably transported in minute quantities with the inventive micropump.

The modified capillary pipette furthermore has an open pipette inlet, which serves for supplying liquid into the interior of the pipette, on its end that lies opposite of the pipette tip. The open pipette inlet is covered by a liquid-permeable filter. The filter forms the interface between the liquid in the supply region and the gas in the gas region in the interior of the pipette. The gas region forms a barrier for the liquid in the supply region and does not allow this liquid to readily enter the interior of the pipette. In order to bridge the gas barrier, the capillary structure extends between the closed pipette tip and the filter on the open pipette inlet. In this way, the working region is fluidically connected to the supply region through the blocking gas region. A continuous exchange of liquid between the two regions is made possible and permanently ensured due to the capillary effect of the provided capillary structure. In this case, a very small volume in the working region is continuously exchanged and kept constant. Without the inventive capillary exchange, the liquid would remain in the working region due to the blocking gas region and the retaining capillary forces and therefore would not exchange itself with the liquid in the supply region. Examinations of changing liquid from the supply region in the working region would not be possible.

The micropump can be constructed of only a few simple constructive elements and requires no external energy supply, particularly also no external pressure supply. It is therefore also particularly cost-efficient. The price of the individual components lies in the single-digit Euro range. The manufacture is likewise simple and cost-efficient. Commercially available components can be easily adapted. In addition to these obvious advantages, another advantage can be seen in achieving a particularly small, constant working region in the capillary section. If minute particles or organisms should be examined, for example, they have to accumulate and therefore concentrate in this small volume. This allows a better observability than in a spatially distributed arrangement. According to a first enhancement of the inventive micropump, it is therefore preferred and advantageous that the working region has a volume in the range between one-fourth and one-third of the volume of the capillary pipette. Commercially available capillary pipettes have capillary tubes with a length between the 45 mm and 120 mm and can have a volume between 1 ml to 10 ml. The length of the capillary pipette can also be shortened in this case. The working region preferably and advantageously has a volume in the range between 0.4 ml and 0.5 ml, e.g. between 400 μl and 500 μl. This is an extremely small volume and the liquid contained therein would without typically not enter into an exchange with the surroundings if no external pressure is applied. The retaining forces would prevent such an exchange from taking place. According to the disclosure, these retaining forces are overcome in a highly effective manner by utilizing liquid-immanent capillary and diffusion forces.

It was already mentioned above that sound observations of the liquid in the working region can be carried out because particles or organisms present in the minute volume are accumulated at this location. According to another inventive embodiment, it is therefore preferred and advantageous that at least the capillary section enclosing the working region is realized transparently. Commercially available capillary pipettes typically consist of glass or of opaque or transparent plastic. Glass pipettes (e.g. of quartz glass) are particularly well suited because they are highly transparent and their open pipette tip can be easily closed by means of fusing or bonding. Plastic pipettes can likewise be used as long as they are translucent. Furthermore, the capillary tubes of conventional capillary pipettes can be realized cylindrically with a constant diameter (piston) or in a conically tapered manner with a decreasing diameter—toward the pipette tip. According to an embodiment, it is preferred and advantageous that the pipette section is conically tapered in the direction of the pipette tip and that the pipette tip is realized cylindrically. Commercially available capillary pipettes can then be modified.

Capillary forces occur on all smooth solid surfaces. They are particularly strong on dense plastic surfaces and glass surfaces. According to another inventive embodiment, it is therefore advantageous and preferred that the capillary structure consists of glass. According to another advantageous embodiment, it is furthermore preferred that the capillary structure is formed by a rod or a tube. Capillary structures of this type likewise are easily available commercially, particularly of glass, and particularly inexpensive. Rods or tubes of plastic or another solid material may also be used. However, it has to be ensured that sufficiently high capillary forces for the exchange of liquid occur in this case. Glass threads and glass rods consist of solid glass such that the capillary effect occurs on their surface. Glass threads have a smaller diameter than glass rods. These may have a diameter, for example, of 1.5 mm or less. Glass tubes consist of hollow glass. The capillary effect primarily occurs on the inner side of the glass tubes. In any case, the outer surface and, if applicable, the inner surface of such capillary structures are sufficiently large such that the liquid to be transported can migrate in both directions (into and out of the working region) due to the capillary effect. Consequently, a bidirectional exchange of liquid between the working region and the supply region takes place. The volume in the working region or capillary section does not change in the process, but rather remains constant. The glass rods or glass tubes advantageously consist of the same glass material as the chosen pipette.

A cylindrical extent of the pipette tip provides the advantage that an inserted rod or tube is axially centered. According to another inventive modification, it is therefore preferred and advantageous that the rod or the tube, particularly a glass rod (or glass thread) or a glass tube, also extends in the pipette tip and is axially centered in the capillary pipette by this pipette tip. In this case, the rod or tube has such a diameter that it is on the one hand properly guided in the pipette tip, but a remaining annular gap in the conical pipette section is on the other hand sufficiently large for enabling the small liquid volume to easily accumulate. The particles or organisms to be examined can then easily accumulate and be represented in the annular gap. The insertion of the rod or the tube up to the pipette tip reliably ensures that the entire working region is penetrated by the capillary structure and subjected to the continuous exchange of liquid with the supply region. The axial centering prevents the rod or tube from contacting the inner wall of the capillary section. In this way, the entire outer surface of the rod or tube is available for the liquid transport in both directions. The effective capillary forces basically are so high that it is according to another inventive embodiment possible to arrange the capillary pipette in any orientation. The capillary pipette or the entire micropump can be arranged vertically, as well as horizontally and also obliquely. The capillary-driven exchange of liquid between the working region and the supply region reliably takes place in any orientation of the micropump.

The ability to arbitrarily orient the micropump is advantageous with respect to the realization of the supply region. This supply region may be a constructive part of the micropump and be directly connected to the pipette inlet, e.g. in the form of a small container (enclosed or with flow-through connection) or an elastic balloon. In this case, the micropump typically is arranged vertically. According to another inventive embodiment, however, the supply region preferably and advantageously can also be formed by a region of an open body of water, e.g. a lake or a bay, wherein the supply region also directly adjoins the pipette inlet in this case. It is advantageous and preferred that the capillary pipette is in this case completely immersed in the supply region. The micropump is placed into the body of water either directly or in a water-permeable housing or cage such that the supply region (the region of the body of water that particularly adjoins the pipette inlet) completely surrounds the micropump. Consequently, the micropump lying on the bottom of a body of water or a cage ptypically is arranged horizontally. An oblique arrangement may also be chosen so as to not impair the circulation of liquid at the pipette inlet, wherein the micropump is placed against an object in such an oblique arrangement and the pipette inlet points upward.

If the micropump is completely immersed in the supply region, the composition of the liquid located therein may be known or unknown. This liquid frequently is natural water of unknown composition and contains a plurality of minute particle and organisms. However, these particles and organisms typically are not the subject of examinations and therefore should not be admitted into the interior of the micropump. According to another modification, it is therefore preferred and advantageous that the filter has a mesh width that is adapted to minute particles and organisms to be retained in the supply region. The filter is arranged on the pipette inlet and permeable to liquids. The filter retains undesirable foreign matter with a size above the mesh width of the filter, but still allows water to advance into the working region along the adjoining capillary structure due to the effective capillary forces. However, since the claimed micropump operates without external application of pressure, it is only possible to use minimum mesh widths that do not impair the liquid transport due to diffusion pressure. The capillary structure, preferably a glass rod or a glass tube, extends up to and contacts the filter material. This is realized in a particularly reliable manner if the capillary structure slightly protrudes beyond the end of the capillary pipette at the pipette inlet, e.g. by approximately 1 mm to 3 mm. In this case, the filter may slightly bulge outward in the region of the capillary structure if it is realized flexibly. According to an embodiment, it is therefore advantageous and preferred that the filter is realized in the form of flexible gauze. A gauze mesh width of 50 μm is particularly preferred for the purely diffusion-driven exchange of liquid. This mesh width makes it possible to retain undesirable foreign matter and to simultaneously allow the admission of substances to be detected or nourished into the interior of the pipette together with the liquid. According to another inventive enhancement, it is preferred and advantageous to permanently arrange the flexible gauze in front of the pipette inlet of the capillary pipette by fastening the gauze with the aid of an elastic sealing ring that is slipped over the pipette inlet. In this case, the gauze is simply placed over the open pipette inlet and fixed by slipping over the elastic sealing ring consisting, for example, of flexible rubber. Particles that are larger than the chosen mesh width of the gauze are reliably retained in the supply region.

The micropump including the above-described advantageous modifications is, if a transparent pipette section is used, particularly advantageous for use in measuring equipment for fluorescence measurements. Substances or living organisms in the liquid can be accumulated within the smallest of spaces in the working region of the micropump and examined with respect to their fluorescence properties (stimulated fluorescence and autofluorescence). The signal strength is sufficiently high due to the high concentration of the substance to be examined in the working region. It is considerably higher than in a spacious distribution of the particles or organisms to be detected in a larger working region. This preferably and advantageously makes it possible to carry out fluorescence measurements on living marine organisms that have accumulated in the working region filled with liquid from the supply region. In this context, it is once again preferred and advantageous that the supply region is formed by a region of an open body of water and that the capillary pipette is completely immersed in the supply region. It is possible to use all living marine organisms that have autonomous fluorescent properties or fluorescent properties that can be stimulated, e.g. also algae. It is preferably and advantageously also possible to use marine flatworms, which exhibit a significantly increased autofluorescence upon contamination with toxic matter contained in the liquid from the supply region; in this context, see also patent DE 10 2014 012 130 B3 of the present applicant, which pertains to the in-situ detection of toxins in bodies of water by means of genetically modified organisms. More details on this and on the above-described modifications can be gathered from the following exemplary embodiments.

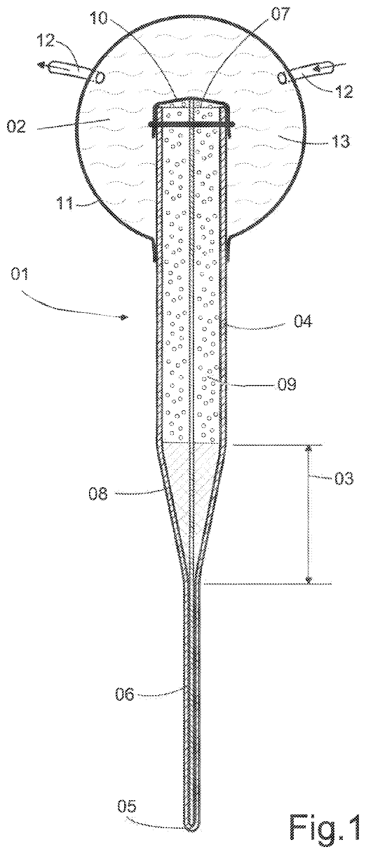

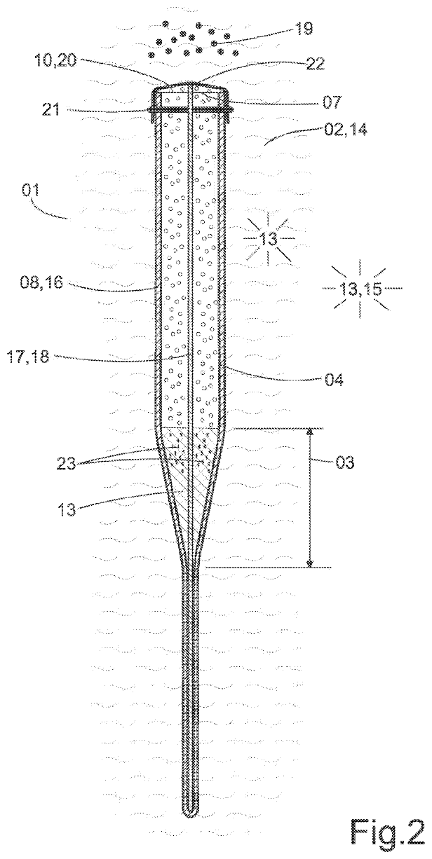

FIG. 1 shows a micropump 01 for exchanging liquid between a supply region 02 and a working region 03. The micropump 01 comprises a modified capillary pipette 04 that preferably consists of glass. The capillary pipette 04 has a closed pipette tip 06 on its lower end 05 and an open pipette inlet 07 lying opposite thereof The working region 03 is enclosed by a pipette section 08 that is arranged above the closed pipette tip 06. An enclosed gas region 09 is located above the working region 03. The pipette inlet 07 is covered by a liquid-permeable filter 10. The filter 10 is located directly adjacent to the supply region 02. The supply region 02 is defined by a balloon 11 in FIG. 1. This balloon has connections 12 in order to allow a liquid 13 (typically water or an aqueous liquid) to pass through the balloon. A preferred embodiment of the micropump 01 is illustrated in FIG. 2. Reference symbols that are not elucidated with reference to this figure can be gathered from FIG. 1.

FIG. 2 shows an embodiment of the micropump 01, in which the supply region 02 is formed by a region 14 of an open body of water 15. Consequently, the liquid 13 from the open body of water 15 is also located in the supply region 02 of the micropump 01. The capillary pipette 04 is completely immersed in the supply region 02. The capillary pipette 04 is oriented vertically in the exemplary embodiment shown. A horizontal or oblique orientation is also possible. The liquid 13 is likewise located in the working region 03. This liquid respectively originates from the supply region 02 or the region 14 and therefore from the open body of water 15. The enclosed gas region 08 filled with air 16 is located above the working region 03. In order to accomplish a continuous exchange of liquid between the region 14 (supply region 02) and the working region 03 through the gas region 08, both of these regions are connected to one another by means of a capillary structure 17. This capillary structure is formed by a rod 18 consisting of solid glass in the exemplary embodiment shown. It is likewise possible to use a hollow tube that preferably also consists of glass.

In FIG. 2, the region 14 (supply region 02) is a portion of a body of water 15, which may also contain minute particles and organisms that are undesirable with respect to the exchange of water by means of the micropump 01. In order to prevent the admission of these particles and organisms into the interior of the capillary pipette 04, a filter 10 that retains the minute particles and organisms 19 in the region 14 is placed over the open pipette inlet 07. The filter 10 is realized in the form of gauze 20 in the exemplary embodiment shown. This gauze is flexible and securely fastened on the pipette inlet 07 by means of an elastic sealing ring 21 (rubber ring) that is slipped over the pipette inlet. In the order to ensure that the exchange of liquid can reliably take place through the filter 10 as a result of capillary forces, the capillary structure 17 (in this case the rod 18) slightly protrudes beyond the pipette inlet 07 (this is not illustrated true to scale and rather exaggerated in FIG. 2). This causes the gauze 20 to slightly bulge outward. The upper end 22 of the rod 18 is pressed against the gauze 20. The liquid 13 comes in contact with the rod 18 through the mesh of the gauze 20 and then creeps into the working region 03 along the rod. Liquid 13 from the working region 03 reaches the region 14 (supply region 02) in the opposite direction. The continuous exchange of liquid through the gas region 08 and the filter 10 is reliably ensured while the volume of the working region 02 remains constant.

A few details regarding the potential dimensions of the micropump 01 are described below, but merely intended to exemplify the proportions. Different dimensions can be readily realized and the cited dimensions should be interpreted as approximate values. In the exemplary embodiment shown, the capillary pipette 04 of glass has an overall length of 75 mm. The pipette tip 06 is realized cylindrically and has a length of 25 mm. The pipette section 09 surrounding the working region 03 is conically tapered in the direction of the pipette tip 06 and has a length of 15 mm. The gas region 08 above the working region 03 accordingly has a length of 35 mm. The capillary pipette 04 has an overall volume of 1.3 ml (overall volume between 1.2 ml and 1.5 ml), wherein the working region 03 comprises approximately one-fourth of the overall volume. The working region 03 comprises 400 μl (0.4 ml, working region 03 between 0.3 ml and 0.5 ml) in the exemplary embodiment shown. The pipette tip 06 has an inside diameter of 2 mm. The closed semicircular rounding of the pipette tip 06 has an inside radius of 1 mm. The rod 18 has a length of 76 mm and a thickness of 1.5 mm, wherein its ends are semicircularly rounded with a radius of 0.75 mm. The rod 18 therefore is axially guided in the pipette tip 06 during its insertion. A concentric annular gap remains around the inserted rod 18. This annular gap suffices for an easy insertability of the rod 18 into the pipette tip 06. However, no working region 03 is formed in the annular gap of the pipette tip 06. The working region 03 begins above the pipette tip 06 and is enclosed by the conical pipette section 09. The inserted rod 18 extends up to the closed end 05 of the pipette tip 06. Since it is dimensioned slightly longer than the capillary pipette 04, it protrudes by approximately 1 mm on the pipette inlet 07. This protrusion suffices for sound contact with the gauze 20 and therefore with the liquid 13 present in the mesh thereof. The gauze 20 preferably has a mesh width of 50 μm, which proved optimal for the exchange of liquid because it is not obstructive. The pipette inlet 07 has an inside diameter of 6 mm. The entire capillary pipette 04 is realized transparently in the exemplary embodiment shown. The pipette section 09 in particular is realized transparently. The working region 03 therefore is visible from outside and transmissive. Consequently, the micropump 01 is particularly well suited for use in measuring equipment for fluorescence measurements. The procedure for the modification of the capillary pipette 04 and the use of the micropump 01 for fluorescence measurements with living organisms is briefly described below.

The modified capillary pipette 04 of the micropump 01 may serve as a container for keeping marine flatworms 23 (Macrostomum lignano) for at least 10 days in a small volume, in which fluorescence measurements are regularly carried out. The small volume is necessary in order to be able to measure the bundled, emitted fluorescence signal during the irradiation of the flatworms 23 with a corresponding stimulation wavelength. To this end, the micropump 01 is vertically integrated into correspondingly constructed measuring equipment. The measurement initially takes place above water (test measurements). Subsequently, in-situ underwater measurements are carried out in order to detect potential toxic matter in the (sea) water based on the measured fluorescence signals of the flatworms 23. The capillary pipette 04 with a water-conveying capillary structure 17 in the form of the rod 18 proves to be an optimal caging and measuring container for fluorescence measurements with the flatworms 23. The claimed micropump 01 is highly effective for this purpose. An efficient, uncomplicated exchange of water is realized within a few hours with very cost-efficient means. The flatworms 23 are not negatively affected in any way and no interference in the fluorescent measurements takes place.

In the manufacture of the modified capillary pipette 04, a conventional Pasteur pipette of glass is shortened on the top and on the bottom, wherein the lower end 05 of the pipette tip 06 is fused shut and the capillary pipette 04 is thoroughly rinsed out with ethanol and tap water. Subsequently, the capillary structure 17 (rod 18 of the same material as the capillary pipette 04) is vertically inserted into the pipette tip 06 such that the lower end of the rod 18 rests on the closed lower end 05 of the pipette tip 06. This suffices for causing the upper end of the rod 18 to slightly protrude from the pipette inlet 07. Flatworms 23 and liquid 13 are transferred into the capillary pipette 04 with an Eppendorf pipette and the liquid 13 in the working region 03 is corrected to the desired volume such that an air-filled gas region 08, which is penetrated by the rod 18, is formed between the working region 03 and the supply region 02. Subsequently, the capillary pipette 04 is closed with gauze 20 and a rubber sealing ring 21 and placed into the region 14 of the open water 15. Liquid 13 is then exchanged between the supply region 02 and the working region 03 via the rod 18 without filling up the capillary pipette 04 or losing volume or flatworms 23.

The micropump 01 already has been successfully used for fluorescence measurements of marine flatworms 23 under laboratory conditions. The exchange of liquid via the rod 18 was verified in preliminary tests in a small aquarium. The capillary pipette 04 was filled halfway with an undyed liquid 13 (water, medium, surrounding water), provided with the rod 18, closed with the gauze 20 and horizontally placed into the aquarium (open water 15), the supply region 14 of which was filled with dyed liquid 13, for a total of 20.5 h. Absorption measurements were carried out during this time period within regular time intervals. These measurements already showed—in comparison with the absorption values of a dilution series of the dyed liquid 13 as reference (without capillary structure 17)—a distinct exchange of liquid after a few hours. Consequently, the micropump 01 with its modifications is particularly suitable for fluorescence measurements on living organisms; compare also to DE 10 2014 012 130 B3.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE CHARACTERS

01 Micropump
02 Supply region
03 Working region
04 Capillary pipette
05 Lower end of 06
06 Pipette tip
07 Pipette inlet
08 Pipette section
09 Gas region
10 Filter
11 Balloon
12 Connection
13 Liquid
14 Region of 15
15 Open body of water
16 Air
17 Capillary structure
18 Rod as 17
19 Particle
20 Gauze as 10
21 Sealing ring
22 Upper end of 18
23 Flatworm

1. A micropump for exchanging liquid between a supply region and a working region, wherein an enclosed gas region is located above the working region, the micropump comprising:
a capillary pipette having a closed pipette tip on a first end, an open pipette inlet disposed opposite the first end and a pipette section enclosing the working region and disposed in a direction of the open pipette inlet from the closed pipette tip;
a liquid-permeable filter covering the open pipette inlet and being connected to the supply region; and
a capillary structure extending through the gas region between the closed pipette tip and the liquid-permeable filter.

2. The micropump according to claim 1,
wherein
the working region has a volume in a range of one-fourth to one-third of a volume of the capillary pipette.

3. The micropump according to claim 2,
wherein
the working region has a volume in a range of 0.4 ml to 0.5 ml.

4. The micropump according to claim 1,
wherein
the pipette section enclosing the working region is transparent.

5. The micropump according to claim 1,
wherein
the pipette section is conically tapered in a direction of the pipette tip, and wherein the pipette tip is cylindrical.

6. The micropump according to claim 1,
wherein
the capillary structure comprises glass.

7. The micropump according to claim 1,
wherein
the capillary structure comprises a rod or a tube.

8. The micropump according to claim 7,
wherein
the rod or the tube is axially centered in the capillary pipette by the pipette tip.

9. The micropump according to claim 1,
wherein
the capillary pipette is configured to be arranged in any orientation.

10. The micropump according to claim 1,
wherein
the supply region is formed by a region of an open body of water and the capillary pipette is completely immersed in the supply region.

11. The micropump according to claim 1,
wherein
a mesh width of the liquid-permeable filter is adapted to minute particles and organisms to be retained in the supply region.

12. The micropump according to claim 11,
wherein
the liquid-permeable filter comprises flexible gauze having a mesh width around 50 μm.

13. The micropump according to claim 12,
wherein
the gauze is fastened by an elastic sealing ring slipped over the pipette inlet.

14. A method for performing fluorescence measurements using measuring equipment, the method comprising: providing the measuring equipment with the micropump according to claim 4.

15. The method according to claim 14,
wherein
the fluorescence measurements are carried out on living marine organisms, which are accumulated in the working region filled with liquid from the supply region.

16. The method according to claim 15,
wherein
the supply region is formed by a region of an open body of water and the capillary pipette is completely immersed in the supply region.

17. The method according to claim 15,
wherein
the living marine organisms are flatworms that exhibit a significantly increased autofluorescence upon contamination with toxic matter contained in the liquid.
